(19) United States
(12) Patent Application Publication
(10) Pub. No.: US 2025/0369806 A1
(43) Pub. Date: Dec. 4, 2025

(54) WIRELESS TEMPERATURE SENSING SYSTEM

(71) Applicant: ThermoWorks Inc., American Fork, UT (US)

(72) Inventors: John Randall Owen, Alpine, UT (US); Kevin Owen, American Fork, UT (US)

(21) Appl. No.: 19/228,409

(22) Filed: Jun. 4, 2025

Related U.S. Application Data
(60) Provisional application No. 63/656,009, filed on Jun. 4, 2024.

(51) Int. Cl. G01K 1/024; G01K 1/02; G01K 15/00

(52) U.S. Cl. CPC G01K 1/024; G01K 1/026; G01K 1/028; G01K 15/005; G01K 2207/04; G01K 2207/06

(57) ABSTRACT

A system for culinary temperature monitoring includes a wireless sensor device, a gateway device, and other network-connected components such as a server device. The sensor device measures the temperature of a food product and transmits temperature data via a sub-GHz communication protocol. The gateway device receives the temperature data and forwards it to a server device using a different network communication protocol, such as MQTT over Wi-Fi. The server device may process, store, or forward the data to a client device for display. The system supports dynamic sensor behavior, such as adjustable transmission intervals and configuration updates. This architecture facilitates long-range, low-power wireless transmission through cooking enclosures, and facilitates multi-sensor, multi-gateway, and real-time cloud-connected cooking environments.

### CROSS-REFERENCE TO RELATED APPLICATIONS

This application claims priority to and the benefit of U.S. Provisional Patent Application No. 63/656,009, filed on Jun. 4, 2024, which is hereby incorporated by reference in its entirety.

### BACKGROUND OF THE DISCLOSURE

Conventional culinary temperature monitoring systems often rely on wired probes and/or short-range wireless technologies such as Bluetooth, which can be limited by signal interference, reduced range, and poor performance in enclosed cooking environments such as ovens, smokers, or grills. These systems may also require manual configuration or close-range pairing, limiting their scalability and adaptability in dynamic cooking scenarios. Additionally, the integration of multiple probes, real-time cloud connectivity, and automated configuration updates remains a challenge for many conventional systems, particularly in commercial or multi-zone cooking applications.

### SUMMARY

In some embodiments, a method for monitoring culinary temperatures includes receiving, at a gateway device, temperature data transmitted from a sensor device via a sub-gigahertz (sub-GHz) communication protocol, the temperature data being based on a temperature of a food product measured with a temperature sensor of the sensor device. The method includes transmitting the temperature data from the gateway device to a server device via a network communication protocol that is different from the sub-GHz communication protocol. The method further includes causing the temperature of the food product to be displayed on a client device based on the temperature data being received by the server device over the network communication protocol. In some embodiments, the method is performed by a computer system. In some embodiments, the method is performed as instructions stored on a computer-readable storage medium.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 illustrates an example environment including various components of a system for monitoring culinary temperatures, according to at least one embodiment of the present disclosure;

FIG. 2 illustrates an example of a sensor device, according to at least one embodiment of the present disclosure;

FIG. 3 illustrates an example of a gateway device, according to at least one embodiment of the present disclosure;

FIGS. 4A and 4B illustrate example views of the sensor device positioned within a cradle, according to at least one embodiment of the present disclosure;

FIG. 5A illustrates an example communication sequence for transmitting temperature data through the system environment of FIG. 1, according to at least one embodiment of the present disclosure;

FIG. 5B illustrates an example communication sequence for updating configuration data through the system environment of FIG. 1, according to at least one embodiment of the present disclosure;

FIG. 6 illustrates a flow diagram for a method or a series of acts for monitoring culinary temperatures, according to at least one embodiment of the present disclosure; and

FIG. 7 illustrates certain components that may be included within a computing system.

### DETAILED DESCRIPTION

This disclosure generally relates to systems and methods for monitoring and managing temperature conditions using wireless sensor devices for culinary or food preparation applications. In particular, the disclosure describes embodiments of a distributed temperature management system that includes one or more sensor devices configured to measure temperature and transmit related data over a sub-GHz radio frequency communication protocol to one or more gateway devices. The gateway device, in turn, communicates with cloud-based or local servers and client devices to facilitate real-time monitoring, data processing, user interaction, and system configuration. These systems and methods may be implemented in consumer or commercial contexts, such as home kitchens, barbecue settings, restaurants, industrial cooking facilities, and/or food transport systems.

In at least one embodiment, the sub-GHz communication may facilitate reliably operating the sensor devices within enclosed cooking environments, such as inside grills or ovens which may typically inhibit higher-frequency protocols like Wi-Fi or Bluetooth. To support reliable operation, the system enables dynamic adjustments of sensor transmission behavior, secure communication over multiple interfaces, and real-time interaction through mobile or web-based client applications. Various implementations may support multiple sensor devices, multiple gateways, calibration workflows, and/or remote configuration updates to provide improvements to safety, convenience, and consistency in temperature-monitoring applications.

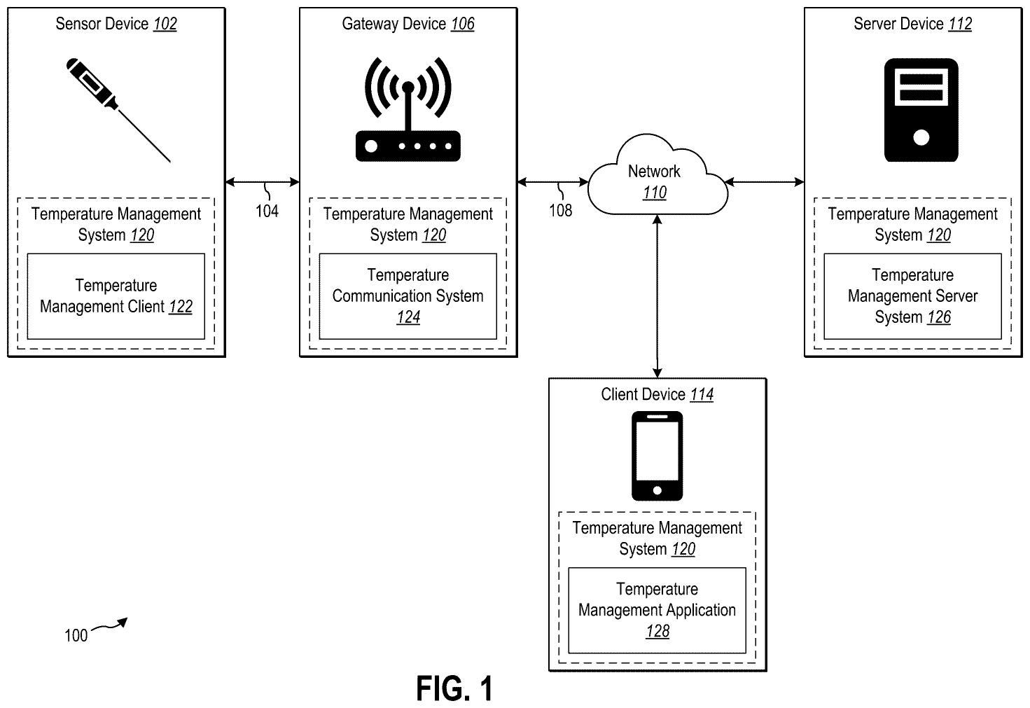

FIG. 1 illustrates an example environment 100 including various components of a system for monitoring culinary temperatures. The environment 100 may be used to detect and transmit the temperature of a food product, and display the temperature at a client device, among other functions. In this way, the system may be used during preparation, cooking, storage, and/or transport of food to improve consistency, safety, and/or visibility in both consumer and commercial applications.

The environment 100 includes a sensor device 102. The sensor device 102 may include a temperature sensor configured to detect the temperature of a food product within which the sensor device 102 is positioned. For instance, the sensor device 102 may be a probe, thermometer, or other culinary temperature sensing device. The sensor device 102 may be configured to send and receive communications over a sub-GHz communication protocol 104, which operates as a radio frequency (RF) communication link between the sensor device 102 and the gateway device 106. For instance, the sensor device 102 may take temperature measurements and may transmit temperature data using the sub-GHz communication protocol 104. In some cases, the sensor device 102 receives data over the sub-GHz communication protocol.

The environment 100 also includes a gateway device 106. The gateway device 106 may be located within wireless range of the sensor device 102. The gateway device 106 may be configured to receive transmissions from the sensor device 102 over the sub-GHz communication protocol 104. In some cases, the gateway device 106 transmits data to the sensor device 102 over the sub-GHz communication protocol 104.

The gateway device 106 may also be configured to communicate with a network 110 over a network communication protocol 108 that is different than the sub-GHz communication protocol 104. The network communication protocol 108 is implemented as an RF communication link in cases where the gateway device 106 uses Wi-Fi, cellular, or similar wireless technology. The gateway device 106 may communicate over the network 110 with one or more other devices, such as a server device 112 and/or a client device 114. For example, the gateway device 106 may forward temperature data over the network 110. The network 110 may be a local or wide area network. In some embodiments, the network 110 includes one or more routers or cloud-based services. In some embodiments, the network 110 includes one network and/or device operating via one protocol, or may include multiple networks and/or devices operating via multiple protocols. For instance, the gateway device 106 may connect to the network 110 via the network communication protocol 108, and further connectivity with the server device 112 via the network 110 may take place based on one or more additional protocols. In some cases, the network 110 includes the internet.

The server device 112 may be implemented as a remote server or cloud-based platform for implementing one or more features of a temperature management system 120. For instance, the server device 112 may be configured to receive temperature data from the gateway device 106 over the network 110 (e.g., via the network communication protocol 108 or other protocol). The server device 112 may store, process, evaluate, modify, augment, interpret, and/or forward the temperature data.

The client device 114 may be a mobile phone, tablet, or other computing device and may be configured to communicate with the server device 112 over the network 110. For instance, the client device 114 may request, receive, and/or display temperature data. In some embodiments, the client device 114 presents the data in real time and/or may issue alerts or status messages based on the data received.

As shown in FIG. 1, each of the sensor device 102, gateway device 106, server device 112, and client device 114 includes a portion of a temperature management system 120. The temperature management system 120 may include software, firmware, hardware, and/or logic for implementing one or more features of the system described herein. The temperature management system 120 is illustrated as dashed boxes within each device to indicate that the system, or a portion thereof, may be implemented entirely or partially on any one of the devices in the environment 100, or across any combination of the devices.

In some embodiments, the temperature management system 120 is distributed across two or more of the devices. For instance, the sensor device 102 and the server device 112 may each implement a distinct portion of the temperature management system 120, such as a local data acquisition module and a remote data processing module, respectively. In another example, the temperature management system 120 may be primarily implemented on the gateway device 106, which may coordinate both RF communication with the sensor device 102 and cloud-based communication with the server device 112, while the other devices implement only lightweight or supporting functionality.

The sensor device 102 includes a temperature management client 122 as part of the temperature management system 120. The temperature management client 122 may be configured to obtain temperature measurements from a temperature sensor positioned in or on the sensor device 102. In some embodiments, the temperature management client 122 formats or processes the temperature data prior to transmission. For instance, the temperature management client 122 may apply calibration values or unit conversions to the measured data.

The temperature management client 122 may also be configured to generate transmission packets for delivery over the sub-GHz communication protocol 104. As described herein, in some cases, the temperature management client 122 initiates wireless transmissions according to a fixed or dynamically adjustable schedule. The temperature management client 122 may also be configured to receive data from the gateway device 106 over the sub-GHz communication protocol 104, such as configuration data indicating a transmission interval, operating mode, and/or other sensor parameters.

As shown, the gateway device 106 includes a temperature communication system 124 as part of the temperature management system 120. The temperature communication system 124 may be configured to receive temperature data from the sensor device 102 over the sub-GHz communication protocol 104. In some embodiments, the temperature communication system 124 receives other types of data as well, such as battery level, device status, environmental measurements, or other information. The temperature communication system 124 may process or reformat the received data for transmission to the server device 112. For example, the temperature communication system 124 may encapsulate the data in a network message compatible with the network communication protocol 108.

In some cases, the network message is formatted according to an internet protocol (IP) and/or a message queuing telemetry transport (MQTT) protocol. The temperature communication system 124 may also transmit data to the sensor device 102 over the sub-GHz communication protocol 104. For instance, the temperature communication system 124 may transmit configuration data received from the server device 112, such as a change in transmission interval or device mode.

The server device 112 includes a temperature management server system 126 as part of the temperature management system 120. The temperature management server system 126 may be configured to receive temperature data from the gateway device 106 over the network 110. In some embodiments, the temperature management server system 126 stores, filters, aggregates, interprets, modifies, and/or augments the received data. For example, the server system 126 may log temperature measurements for later access and/or compute averages over time intervals. The temperature management server system 126 may also evaluate or interpret temperature data to detect events, such as overcooking, undercooking, rapid temperature shifts, or other events.

In some cases, the server system 126 forwards temperature data and/or derived results to the client device 114 over the network 110. The temperature management server system 126 may also manage configuration settings for the sensor device 102. For instance, the server system 126 may maintain a configuration document that defines transmission intervals, update rates, or device behavior, and may transmit that document to the gateway device 106 for delivery to the sensor device 102.

The client device 114 includes a temperature management application 128 as part of the temperature management system 120. The temperature management application 128 may be configured to receive temperature data and/or related information from the server device 112 over the network 110. In some embodiments, the temperature management application 128 displays temperature readings, including in real time. For instance, the application 128 may present a numerical temperature value, a graph of temperature over time, and/or other visual indicia of a cooking state.

The temperature management application 128 may also generate alerts or notifications based on the received data. For example, the application 128 may alert a user when a target temperature is reached or when abnormal temperature fluctuations are detected. In some cases, these alters and/or notifications are generated by the temperature management server system 126 and are transmitted to the client device for display on the client device. In some cases, the temperature management application 128 allows user interaction or configuration, such as setting thresholds, naming probes, and/or viewing historical data.

In this way, the temperature management system 120 may be implemented across the various devices of the environment 100 in a modular or distributed fashion. Each device may implement a portion of the system and may communicate with other devices using one or more (e.g., RF) communication protocols. In some embodiments, the system includes multiple sensor devices 102 that independently transmit temperature data (e.g., over the sub-GHz communication protocol 104 to the gateway device 106), such as in a multi-probe cooking environment where each probe monitors a separate food item.

In some embodiments, the system includes multiple gateway devices 106 positioned throughout an area, allowing sensor devices to dynamically connect with different gateways based on signal strength and/or availability, and without requiring manual reconfiguration. These and other functionalities may provide flexibility, scalability, and adaptability for temperature monitoring tasks in a variety of cooking applications.

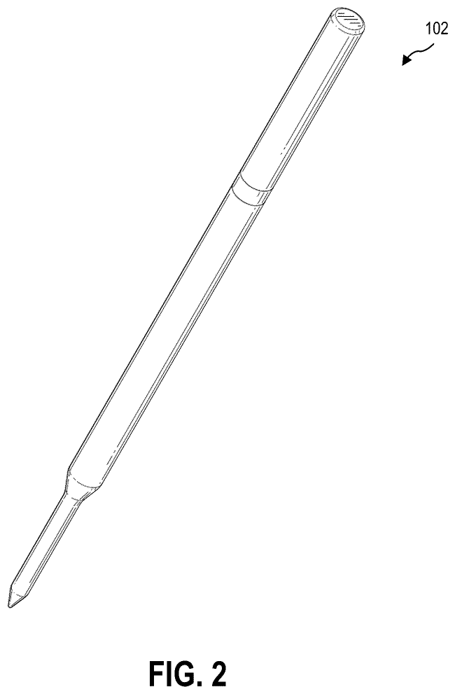

FIG. 2 illustrates an example of the sensor device 102, according to at least one embodiment of the present disclosure. The sensor device 102 may be implemented as a handheld or embedded probe configured to detect a temperature of a food product. For instance, the sensor device 102 may have a housing that has an elongated and/or pointed shape such that the sensor device 102 may be positioned partly or entirely within a food product.

The sensor device 102 may include one or more temperature sensors. In some cases, a temperature sensor is positioned within the housing, at or near a distal end of the housing, such that the temperature sensor is exposed to the internal temperature of the food product when inserted. In some cases, the sensor device 102 may be otherwise positioned with respect to a food product, such as adjacent, contacting, or near the food product, and may be implemented to take measurements of an environment around the food product.

The housing may be constructed from materials suitable for use in high-temperature and food-safe environments. For example, the temperature sensor and housing may be rated for exposure to temperatures up to approximately 575° F. (302° C.), or another operating temperature threshold, allowing the sensor device 102 to be used inside ovens, grills, or similar cooking environments. Internal electronics may be thermally isolated or otherwise positioned to remain below approximately 185° F. (85° C.), or other operating temperature threshold, during operation.

In some embodiments, the housing is also rated for ingress protection, such as an IP69K water resistance rating, which enables the sensor device 102 to withstand high-pressure and/or high-temperature exposure to liquids, such as during cleaning or sanitation. The housing may further include one or more features or forms for gripping, sealing, or placement of the sensor device 102.

In addition to temperature sensor(s), the sensor device 102 may include processing and/or computing components, such as a microcontroller and a memory component. For instance, the sensor device 102 may periodically sample data from the temperature sensor and convert the data into a digital format. In some cases, the raw sensor readings are adjusted using calibration data stored on the sensor device 102. For example, the sensor device 102 may store one or more trim values corresponding to specific temperature calibration points and may apply those values to normalize measured or raw temperature outputs.

In some cases, the calibration data may be communicated to and/or updated on the sensor device 102 via communication with a gateway as described herein. In some cases, the sensor device 102 may monitor its internal battery level (e.g., using the microcontroller), such as by periodically sampling and storing the battery status in memory for transmission and/or logic decisions.

As mentioned above, the sensor device 102 may be configured to transmit temperature data wirelessly using a sub-GHz communication protocol. In some embodiments, the sub-GHz communication protocol operates at a frequency of approximately 433 MHz. In some cases, the sub-GHz communication protocol operates at a frequency of about 915 MHz. In some embodiments, the sub-GHz communication protocol operates in a frequency range of about 422 MHz to about 915 MHz.

The sub-GHz communication protocol may use a predefined packet structure that includes one or more of a header, a payload, or a trailing sequence number. The header may identify the sensor device 102 and/or indicate the type of data included in the payload. The sequence number may increment with each new transmission from the sensor device 102 and may be used by one or more receiving devices to identify duplicate packets. For instance, in a multi-gateway environment, the same transmission from a sensor device 102 may be received by two or more gateway devices.

Each gateway device may forward the received packet to a server device, which may rely on the sequence number to identify and process only the first instance of a given packet while ignoring duplicates from other gateways. This de-duplication mechanism improves reliability and consistency across the system and facilitates implementing multiple gateway devices, for instance, without requiring static sensor assignments or manual coordination. For example, this de-duplication mechanism may facilitate sensor devices roaming and/or dynamically handing off between gateway devices as described below in more detail. In this way, the RF transmissions over the sub-GHz communication protocol may be more resilient to signal loss or interference and may support scalability in larger or denser environments.

In some embodiments, the sub-GHz communication protocol supports transmission ranges of up to approximately 1500 feet in unobstructed environments, and up to approximately 560 feet through cooking enclosures such as grills or ovens.

In some cases, the sub-GHz frequency range provides improved signal penetration through dense, enclosed (or partially enclosed), or otherwise obstructed cooking environments. For example, sub-GHz RF signals may pass more effectively through materials such as stainless steel, ceramic, or other (e.g., thick-walled) enclosures. Thus, the sub-GHz signals may facilitate reliable communication even when the sensor device 102 is positioned inside a grill, oven, or similar cooking apparatus.

In contrast, higher-frequency communication protocols such as Bluetooth, Wi-Fi, or others may suffer from significant signal attenuation when passing through metals, ceramics, or other enclosure and/or heat-retaining surfaces. Accordingly, the sub-GHz communication in this way may provide greater range and/or reliability in challenging culinary environments where other wireless technologies may struggle or fail.

In some embodiments, the sensor device 102 operates based on dynamic transmission intervals, which may be determined based on other RF activity on the sub-GHz communication protocol. For instance, the sensor device 102 may monitor for transmissions from other sensor devices operating on the sub-GHz communication protocol (e.g., within the same or similar RF range) and may defer or reschedule its own transmission accordingly.

The sensor device 102 may be configured to wait a predetermined period after detecting RF activity before transmitting data over the sub-GHz communication protocol. In this way, the dynamic transmission interval may reduce RF congestion, improve battery performance, and/or enable coordination in environments with multiple active sensor devices. In some embodiments, the sensor device 102 may initiate transmissions based on predefined trigger conditions. For example, the sensor device 102 may transmit data in response to detecting (at the sensor device) a temperature value that crosses a defined threshold, such as reaching a target cooking temperature or detecting an abnormal fluctuation. This event-driven behavior may be in addition to, or as an alternative to, periodic transmissions to facilitate low-power operation modes.

In some cases, the sensor device 102 is also configured to receive data over the sub-GHz communication protocol. For example, the sensor device 102 may receive a configuration document or command from a gateway device for implementing specific configuration data. The configuration data may indicate a dynamic transmission interval, sleep schedule, data type, or other operational parameter. For instance, the data type may specify the kind of information the sensor device 102 should transmit, such as food product temperature measurements, ambient temperature measurements, environmental data (e.g., humidity, pressure, etc.), battery level, device status, signal strength, or other data types available to the sensor device 102.

In some embodiments, the data type may also define the format or precision of transmitted values, or indicate that the sensor should enter a mode for sending expanded debug data. The configuration data may instruct the sensor device to enter a debug mode, such as by enabling expanded diagnostic transmissions. In some cases, the configuration data instructs the sensor device to transition to a sleep state, adjust calibration behavior, and/or modify other operational settings. In this way, the sensor device 102 may be advantageously configured via the sub-GHz communication protocol without requiring physical access to the sensor device 102. In some cases, configuration data is transmitted to the sensor device 102 only by a gateway that is designated as the primary gateway for that sensor device, as described herein. In some embodiments, the gateway device automatically transmits configuration data to the sensor device upon the first connection and/or when a version number associated with the configuration has changed.

In some embodiments, the sensor device 102 may be implemented in connection with multiple gateway devices, each of which is capable of receiving transmissions over the sub-GHz communication protocol. The sensor device 102 may broadcast temperature data packets and each gateway device within wireless range may receive those transmissions. In some cases, this may facilitate implementing overlapping gateway coverage areas while not requiring sensor devices to establish or maintain individual connections to specific gateways.

For instance, in these configurations, the temperature management server system 126 receives the same transmissions (from the same sensor) via multiple gateways and may compare corresponding signal strength values (e.g., RSSI), timestamps, or other indicators. Based on this information, the server device 112 may designate one of the gateway devices as a primary gateway for a corresponding sensor device. This designation may be updated dynamically (e.g., by the server) over time as signal conditions or availability change, such as due to physical movement of the sensor device or temporary interference affecting a given gateway.

In some embodiments, although all nearby gateways may continue to receive transmissions from the sensor device 102, only the gateway device designated as primary by the server device 112 may transmit configuration documents or other two-way communications back to the sensor device. This relationship may facilitate dynamic handoff between gateway devices without requiring manual reconfiguration or fixed assignments, and may also support scalability in environments with dense or distributed gateway implementations.

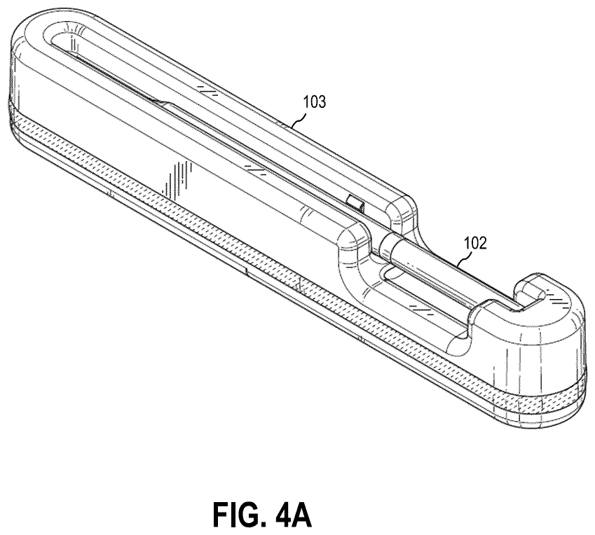

In some embodiments, the sensor device 102 may be positionable within a cradle, dock, case, or stand. The sensor device 102 may support various features associated with the dock, such as that described in connection with FIGS. 4A-4B below. As further described with respect to FIGS. 4A-4B, the sensor device 102 may detect the presence of a magnetic field generated by a cradle, and may enter a low-power or standby mode in response.

In some cases, the same cradle may be configured to charge the internal battery of the sensor device 102. For example, the cradle may deliver power to the sensor device 102 through a conductive path that can include an antenna of the sensor device 102. When removed from the cradle, the sensor device 102 may automatically resume active communication and temperature monitoring behavior.

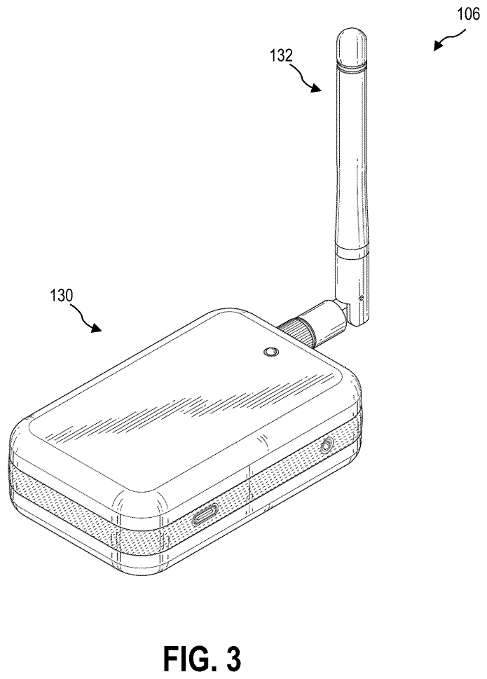

FIG. 3 illustrates an example of the gateway device 106, according to at least one embodiment of the present disclosure. In some cases, the gateway device 106 is implemented as a standalone physical device. In other examples, the gateway device 106 may be representative of a functionality and/or integration of one or more other devices, systems, and/or appliances, such as a display unit, a network router, or a cooking apparatus.

In some embodiments, the gateway device 106 includes a housing 130. The housing 130 may be shaped, sized, and configured for any of a variety of implementations, such as positioning on a countertop, hanging on a wall, or connecting to (or implemented and/or embedded within) a cooking apparatus such as a grill, smoker, or oven. In some cases, the housing 130 includes one or more magnetic elements such that the gateway device 106 may be magnetically positioned on a cooking apparatus or other magnetic surface. The gateway device 106 may be otherwise positioned in any manner with respect to one or more sensor devices.

The gateway device 106 may include an antenna 132, which, as shown, may be an external antenna. The gateway device 106 may include multiple external antennas. In some cases, one or more antennas may be contained within the housing 130. Any of the antennas (including the antenna 132) may be utilized in various configurations for communicating over the sub-GHz communication protocol, Wi-Fi, cellular, Bluetooth, or any other wireless and/or RF communication technique.

The housing 130 may also house circuit components, processing components, memory components, communication components, display or indicator components, power components, or any other hardware or software component for implementing the various functionalities of the gateway device 106 as described in one or more embodiments herein.

In at least one embodiment, the gateway device 106 includes a sub-GHz radio transceiver configured to communicate with one or more sensor devices over the sub-GHz communication protocol. For instance, the gateway device 106 may receive RF transmissions that include temperature readings, calibration values, battery level, signal strength, debug information, or any other sensor data or other information as described herein. As mentioned, the gateway device 106 may also be capable of transmitting information back to the sensor device. For example, the gateway device 106 may transmit configuration data and/or command instructions to adjust the behavior of a connected sensor device.

In addition to the sub-GHz communication protocol, the gateway device 106 includes one or more interfaces for communicating over other communication protocols, such as over the network communication protocol as described herein. The network communication protocol may be implemented using Wi-Fi, Ethernet, cellular, or other wired or wireless technologies. In some embodiments, the network communication protocol is implemented as an RF link to a wireless access point (e.g., Wi-Fi) or cellular base station (e.g., LTE, 5G).

The gateway device 106 may communicate with a server device and/or a client device over a local or wide area network. For instance, the gateway device 106 may communicate over a cloud-based Internet of Things (IoT) platform or any other local or area network. In some cases, the gateway device 106 connects to the network over Wi-Fi, such as via a Wi-Fi router-established wireless network which connects to the internet for communicating with the server device, client device, and/or other devices. In this way, the gateway device 106 may forward data received from one or more sensor devices to the server device over the network communication protocol. The server device may then process, store, or relay the data for further use or display, as mentioned above. In some cases, the gateway device 106 communicates with the network 110 (e.g., one or more devices comprising the network 110) over the network communication protocol 108, and further communication paths to the server device and/or the client device may be via one or more additional communication protocols, such as an MQTT protocol as described herein.

The gateway device 106 may be configured to process and forward temperature data and other information received from sensor device(s). For instance, the gateway device 106 may reformat and/or encapsulate the data in one or more network messages, such as MQTT (message queuing telemetry transport) messages or HTTP requests. In some embodiments, each message includes a topic identifier and a payload that reflects the latest temperature data and associated metadata. The gateway device 106 may forward this data to the server device 112 in real time or according to a configured schedule.

In some embodiments, the gateway device 106 is capable of receiving transmissions from (e.g., coupling with) a plurality of sensor devices simultaneously. For example, a single gateway device 106 may receive and forward data from up to 50 or more probes within RF range, each communicating via the same sub-GHz communication protocol (e.g., the same frequency). This capability may facilitate the gateway device 106 being implemented in connection with a considerable number of sensor devices. In some embodiments, the gateway device 106 maintains a mapping or registry of active sensor devices, including identifiers, connection status, and transmission history.

Although sub-GHz communication is typically used, in some configurations, additional sensor device(s) may be connected to the gateway device via a wired interface. For example, the gateway device 106 may receive data from a wired ambient temperature sensor that is positioned inside a grill or oven to monitor the cooking environment, in addition to receiving wireless temperature data from one or more sensor devices.

As mentioned above, multiple gateway devices 106 may be deployed together within a single network application. In such configurations, each sensor device may dynamically hand off between gateway devices 106 based on signal strength, connectivity, or availability of the gateway device 106. For example, the server device may determine, for each sensor device, which gateway device 106 currently provides the strongest received signal and designate that gateway as the primary gateway for a given sensor device.

Each gateway device 106 may then forward or act upon transmissions only from sensor devices that have designated it as primary. This handoff behavior enables seamless roaming of sensor devices between gateway coverage areas without requiring manual reconfiguration or static assignments. In some embodiments, a gateway device 106 still detects transmissions from all sensor devices within range but ignores, or logs only for diagnostics, data from devices for which it is not the primary gateway.

In some cases, the gateway device 106 may facilitate transmitting configuration data to one or more sensor devices. For instance, the gateway device 106 may receive updated configuration settings from the server device, client device, or other remote system. As described herein, configuration settings may include a transmission interval, debug mode activation, sleep schedule, or other operational parameters.

The gateway device 106 may store, cache, or immediately forward this data to the appropriate sensor device. In some cases, the gateway device 106 may transmit configuration information only to those sensor devices for which it is designated as the primary gateway. In this way, the gateway device 106 may act as an intermediary that enables secure and reliable end-to-end communication between the sensor device and the server device (or one or more other device). In some embodiments, the gateway device 106 also performs security functions, such as authenticating sensor devices, verifying message integrity, and encrypting outgoing transmissions.

In some embodiments, the gateway device 106 supports an account linking or pairing process. For example, a user may place a sensor device in close proximity to the gateway device 106 to initiate pairing. The gateway device 106 may detect the signal strength (e.g., RSSI) of the sensor device and, if above a defined threshold, may enter pairing mode. A visual indicator, such as a blinking LED, may signal that pairing is in progress.

Upon successful detection and registration, the gateway device 106 may send a message to the server device, which may link the sensor device to the same user account as the gateway device 106. In some cases, the server may return an updated configuration document confirming the linkage.

In some configurations, the gateway device 106 may perform various processing operations on sensor data before forwarding it to the server device. For instance, the gateway device 106 may filter, aggregate, and/or transform temperature readings to reduce bandwidth usage or conform to one or more formats (e.g., MQTT format). The gateway device 106 may perform logic operations, such as computing an average over a fixed window, discarding outliers, or other techniques. This processing may be in addition to, or as an alternative to, one or more processing operations which may be performed on temperature data at the server device. In this way, the gateway device 106 may operate as a central coordination point that facilitates reliable connectivity, intelligent communication, and efficient data handling among sensor device(s), the server device, and the client device.

FIGS. 4A and 4B illustrate example views of the sensor device 102 positioned within a cradle 103, according to at least one embodiment of the present disclosure. FIG. 4A shows a perspective view of the sensor device 102 positioned in the cradle 103, and FIG. 4B shows a corresponding top view. In some embodiments, the cradle 103 may be implemented as a dock, stand, case, or other structure configured to receive and hold the sensor device 102. The cradle 103 may be used for storage, charging, and/or transport, of the sensor device 102.

The cradle 103 may include structural features that align and retain the sensor device 102 in place when inserted. In some embodiments, the cradle 103 generates a magnetic field that is detectable by the sensor device 102. In some embodiments, when the magnetic field is detected, the sensor device 102 automatically enters a sleep, standby, or low-power mode, for example, without requiring user input or mechanical switching. For instance, the sensor device 102 may automatically suspend or reduce one or more operations, such as RF transmissions, temperature sampling, or other internal processes. In some cases, the sensor device 102 periodically wakes to check for updates or changes in docking status.

When removed from the cradle 103, the sensor device 102 may be triggered by the absence of a magnetic field and/or by a change in charging state, and may automatically return to an active state and/or resume normal operation. For example, the device may resume temperature measurements and sub-GHz transmissions without requiring manual reactivation.

In some embodiments, the cradle 103 is configured to charge the sensor device 102 while docked. For example, the cradle 103 may deliver power to the sensor device 102 to charge an internal battery of the sensor device 102. In some cases, the sensor device 102 is charged via an antenna of the sensor device 102, for example, which may provide a conductive path to the internal battery. In other embodiments, the cradle 103 may be configured to charge the sensor device 102 wirelessly, such as using inductive coupling or another contactless power transfer technique. Accordingly, the cradle 103 may support both power delivery and power management features, enabling the sensor device 102 to operate efficiently and with minimal user intervention when transitioning between storage and active use.

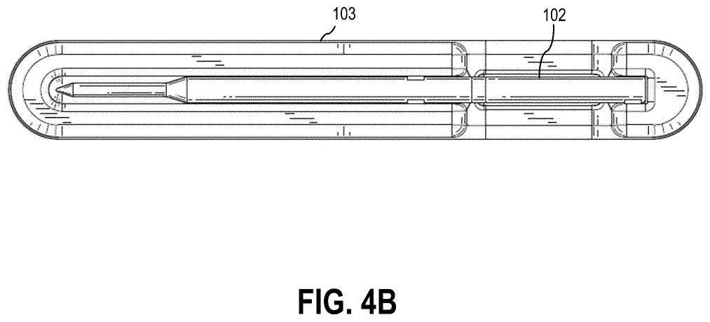

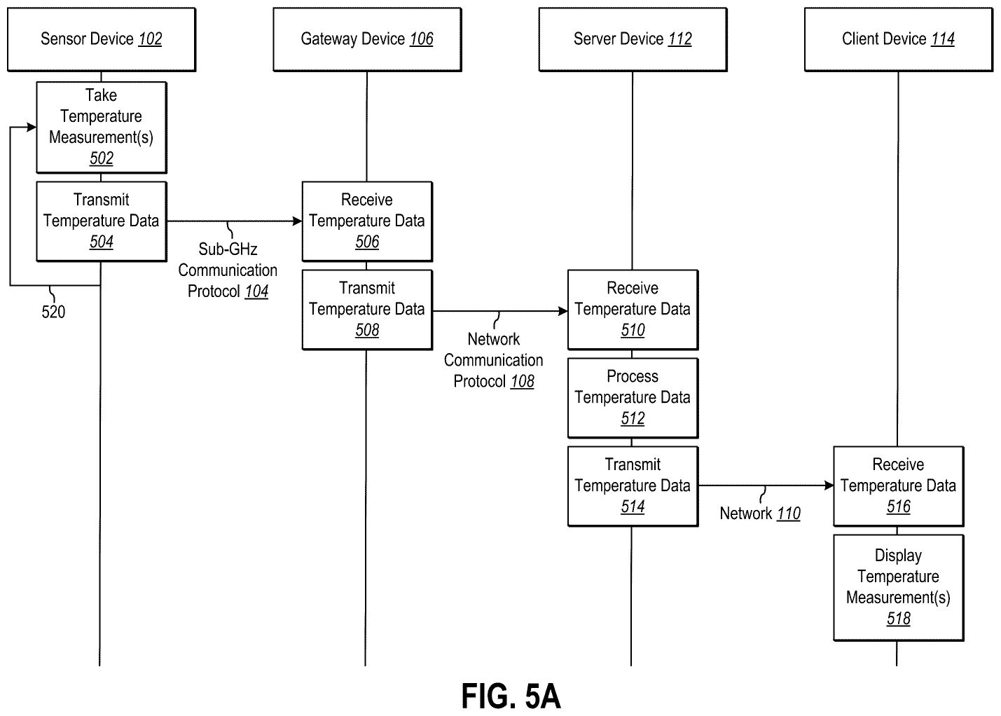

FIG. 5A illustrates an example communication sequence for transmitting temperature data through the system environment 100. As shown, this figure includes a diagram representing interactions between the sensor device 102, gateway device 106, server device 112, and client device 114.

At 502, the sensor device 102 obtains a temperature measurement. In some embodiments, the sensor device 102 samples one or more temperature sensors positioned within or near a food product. The sampling may be performed on a periodic schedule, in response to an internal trigger condition, or in accordance with configuration data received from the gateway device 106 (more details regarding transmitting configuration data are shown and described in connection with FIG. 5B below). This repetition is represented by loop 520. After acquiring the measurement, the sensor device 102 prepares the data for wireless transmission. Preparing the data may include formatting the temperature reading into a digital representation, applying calibration offsets, appending diagnostic values, and/or structuring the output for packaging into a transmission packet.

At 504, the sensor device 102 transmits the temperature data over the sub-GHz communication protocol 104. At 504, the temperature data may refer to any data originating from the sensor device 102, and may include, in addition to or as an alternative to temperature readings, information such as battery status, device identifier, ambient sensor values (e.g., humidity, pressure), signal strength, operational diagnostics, or other information as described herein.

The temperature data is typically encapsulated in a structured packet that includes a header (e.g., identifying the sensor), a payload (e.g., the data fields being transmitted), and a sequence number or timestamp to aid in ordering and de-duplication. The temperature data is transmitted using a sub-GHz RF link, which provides improved signal penetration through enclosure materials such as metal and/or ceramic typical of cooking enclosures.

At 506, the gateway device 106 receives the temperature data. If multiple gateways are present, the temperature data may be received by each gateway device. The gateway device 106 may validate the incoming packet, check for duplicates based on the sequence number, and/or log or buffer the temperature data, or any of this functionality may be performed by the server device 112.

In some embodiments, the gateway reformats or repackages the data in preparation for transmission over a different protocol from the sub-GHz communication protocol 104. Additionally, in some cases, the gateway device 106 may perform processing or interpretation of the received temperature data. For example, the gateway may filter out erroneous values, compute rolling averages, evaluate thresholds for cooking operations, or perform other processing operations.

At 508, the gateway device 106 transmits the temperature data over the network communication protocol 108. At 508, the temperature data may represent data that has been repackaged into a message conforming to an IP-based format, such as an MQTT or HTTP message. The payload may include temperature readings and/or other data originating from the sensor device 102, such as battery status, environmental sensor outputs, or diagnostics. Transmission over the network communication protocol 108 may occur via Wi-Fi, Ethernet, cellular, or other wired or wireless technologies. The gateway device 106 may also implement encryption and/or authentication techniques to secure the outgoing communication.

At 510, the server device 112 receives the temperature data over the network communication protocol 108. The server device 112 may be implemented as a cloud platform or hosted infrastructure. At 512, the server device 112 processes the received data. This processing may involve storage in a time-series database, filtering, aggregation, threshold comparison, analysis interpretation, triggering of event conditions such as alerts, anomaly detection, or other processing. The server device 112 may also integrate the temperature data with configuration documents, device registries, and/or user profiles.

At 514, the server device 112 transmits the temperature data to the client device 114 over network 110. This communication may occur via a real-time protocol such as MQTT, an application programming interface (API), a push notification service, or other techniques. At 514, the temperature data may represent a filtered or reformatted version of the original sensor information, or an interpreted or processed version thereof. Delivery may be asynchronous or near real time, depending on system configuration.

At 516, the client device 114 receives the transmitted data and, at 518, displays the temperature measurement on a display device. This display may include raw values, interpreted messages (e.g., “done” or “still cooking”), graphical representations (e.g., trend lines or gauges), alerts, or other interpretations, measurements, and/or metrics. In some embodiments, the client device 114 may also allow user interaction, such as adjusting thresholds or initiating device commands. Through this flow, the system facilitates timely and intelligent delivery of temperature data from sensor device 102 to end users.

FIG. 5B illustrates an example communication sequence for updating configuration data through the system environment 100. In this example, configuration data is initiated at the client device 114 and selectively propagated through the system based on the scope of the update. This process facilitates dynamic reconfiguration of one or more system components.

At 550, the client device 114 initiates an update to a threshold or parameter. For example, a user may modify a cook timer, a target temperature, a notification threshold, or other settings using a software interface. In some cases, the update may relate to one or more configuration changes for the sensor device 102 such as a dynamic transmission interval update. These changes may affect display logic, alerting behavior, or operational thresholds at one or more devices. At 552, the client device 114 transmits update data indicating the modified parameter over network 110. This update data may include a device identifier, a user ID, and metadata indicating the scope and intended recipients of the update.

At 554, the server device 112 receives the update data from the client device 114. In some embodiments, the server device 112 processes and stores the updated threshold or parameter for use in server-side logic, such as to generate alerts, enable remote notifications, and annotate temperature logs, among other operations. In such cases, the updated value may not be forwarded beyond the server device 112.

In other cases, the updated threshold or parameter may relate to changes at the sensor level, such as a change in temperature sampling frequency, transmission interval, calibration information, operating mode, or other update. When the update pertains to the sensor device 102, the server device 112 prepares and transmits a configuration document reflecting the desired settings. Updates may similarly apply to configurable settings of the gateway device 106.

At 556, the server device 112 generates a configuration document that encodes one or more updated operational parameters. The configuration document may define a transmission interval, debug mode status, sleep schedule, measurement resolution, or other sensor-specific behavior. At 558, the server device 112 transmits the configuration document to the gateway device 106 over the network communication protocol 108.

At 560, the gateway device 106 receives the configuration document. The gateway device 106 may validate the message, verify intended recipients, and/or buffer or cache the configuration for delivery. At 562, the gateway device 106 transmits the configuration document to the sensor device 102 using the sub-GHz communication protocol 104. In some embodiments, the gateway device 106 delivers configuration documents only to sensor devices for which it is currently designated as the primary gateway, for instance, based on signal strength or availability.

At 564, the sensor device 102 receives the configuration document. At 566, the sensor device 102 updates its local parameters in accordance with the instructions contained in the document. This may involve modifying internal schedules, enabling diagnostic output, adjusting thresholds, or altering measurement or transmission behavior. These updates allow the sensor device 102 to dynamically adapt its operation in response to remotely initiated changes, thereby supporting flexible and scalable system behavior without requiring manual interaction or physical access to the probe.

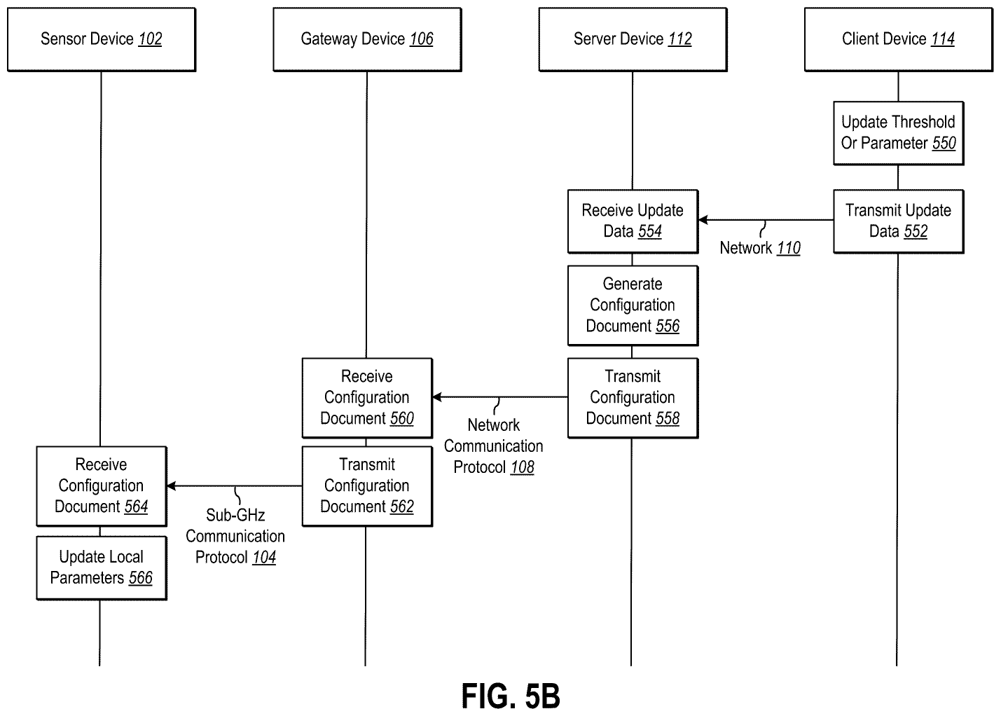

FIG. 6 illustrates a flow diagram for a method 600 or a series of acts for monitoring culinary temperatures, according to at least one embodiment of the present disclosure. While FIG. 6 illustrates acts according to one embodiment, alternative embodiments may add 2, omit, reorder, or modify any of the acts of FIG. 6. In some embodiments, the acts of FIG. 6 are performed as a method. In some embodiments, the acts of FIG. 6 are performed by a computer system. In some embodiments, the acts of FIG. 6 are performed as instructions stored on a computer-readable storage medium.

In some embodiments the method 600 includes an act 610 of receiving temperature data via sub-GHz communication protocol. For example, the act 610 may include receiving, at a gateway device, temperature data transmitted from a sensor device via a sub-GHz communication protocol, the temperature data being based on a temperature of a food product measured with a temperature sensor of the sensor device.

In some embodiments, the method 600 includes an act 620 of transmitting the temperature data via a network communication protocol. For example, the act 620 may include transmitting the temperature data from the gateway device to a server device via a network communication protocol that is different from the sub-GHz communication protocol.

In some embodiments, the method 600 includes an act 630 of causing the temperature to be displayed. For example, the act 630 may include causing the temperature of the food product to be displayed on a client device based on the temperature data being received by the server device over the network communication protocol.

In some embodiments, the network communication protocol is an internet protocol (IP)-based network protocol. In some embodiments, the network communication protocol is a message queuing telemetry transport (MQTT) protocol. In some embodiments, transmitting the temperature data from the gateway device includes formatting the temperature data as a network message comprising a topic identifier and a message payload compatible with the MQTT protocol. In some embodiments, receiving the temperature data includes receiving the temperature data at a dynamic transmission interval of the sensor device, the dynamic transmission interval comprising one or more delayed transmissions in response to the sensor device detecting one or more active transmissions of one or more additional sensor devices.

In some embodiments, the sensor device measures the temperature of the food product based on the sensor device being at least partially positioned within the food product. In some embodiments, causing the temperature of the food product to be displayed on the client device includes transmitting the temperature data from the server device to the client device, the temperature data including instructions for displaying the temperature on the client device. In some embodiments, the temperature data includes an adjusted temperature of the food product as measured and calibrated by the sensor device. In some embodiments, the temperature data indicates one or more of an ambient temperature, a battery level, device information, or debug data for the sensor device, and further comprising causing one or more of the ambient temperature, battery level, device information, or debug data to be displayed on the client device based on the temperature data being received at the server device.

In some embodiments, the method 600 further includes, with the gateway device, receiving additional temperature data transmitted from an additional sensor device, wherein the additional temperature data is based on a temperature of an additional food product or an ambient temperature; and transmitting the additional temperature data to the server device via the network communication protocol for displaying the temperature of the additional food product or the ambient temperature on the client device. In some embodiments, the additional temperature data is received via the sub-GHz communication protocol. In some embodiments, the additional temperature data is received via a wired connection of the additional sensor device with the gateway device.

The method of claim 1, wherein the sub-GHz communication protocol operates at a frequency of about 433 MHz to about 915 MHz. In some embodiments, receiving the temperature data at the gateway device includes receiving the temperature data transmitted through an enclosure of a cooking apparatus. In some embodiments, receiving the temperature data includes receiving the temperature data over the sub-GHz communication protocol with the gateway device from up to 1500 feet away from the sensor device without obstruction. In some embodiments, receiving the temperature data includes receiving the temperature data over the sub-GHz communication protocol with the gateway device through an enclosure of a cooking apparatus from up to 560 feet away from the sensor device.

In some embodiments, the method 600 further includes transmitting configuration data to the sensor device via the sub-GHz communication protocol, wherein the configuration data indicates a dynamic transmission interval for the sensor device to implement. In some embodiments, the gateway device is one of a plurality of gateway devices accessible to the sensor device via the sub-GHz communication protocol, and the method 600 further includes transmitting the configuration data to the sensor device from the gateway device in response to the server device determining that the gateway device has a strongest signal strength among the plurality of gateway devices and in response to the server device designating the gateway device as a primary gateway device for the sensor device.

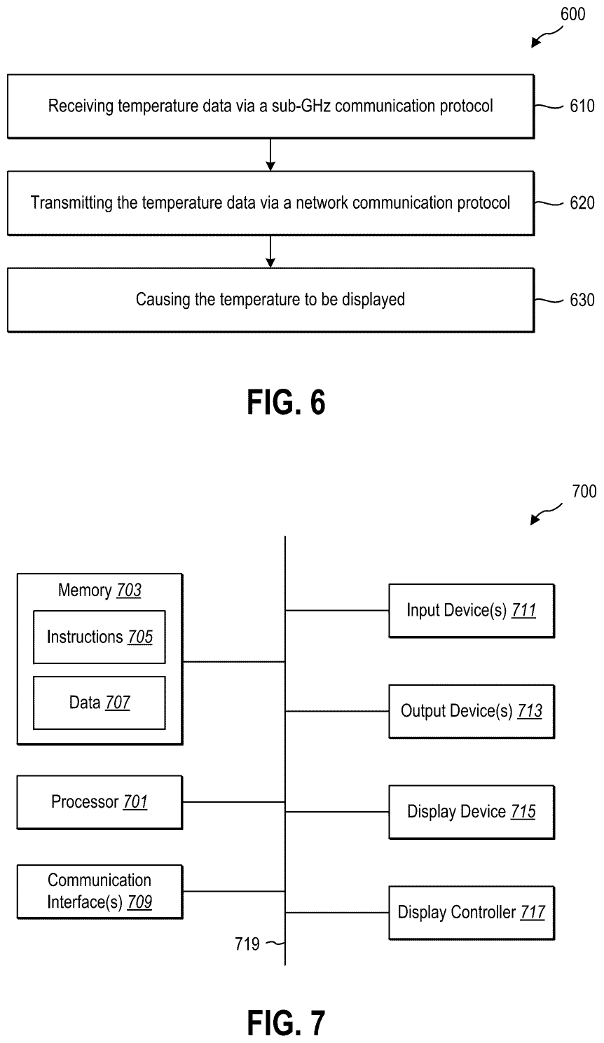

Turning now to FIG. 7, this figure illustrates certain components that may be included within a computer system 700. One or more computer systems 700 may be used to implement the various devices, components, and systems described herein.

The computer system 700 includes a processor 701. The processor 701 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may include computer-readable storage media and can be any available media that can be accessed by a general purpose or special purpose computer system. Computer-readable media that store computer-executable instructions are non-transitory computer-readable media (devices). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer-readable program code that allows the performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 709 may connect the computer system 700 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into one or more of text, graphics, or moving images (as appropriate) shown on the display device 715.

The various components of the computer system 700 may be coupled together by one or more buses, which may include one or more of a power bus, a control signal bus, a status signal bus, a data bus, other similar components, or combinations thereof. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer-executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses, are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for monitoring culinary temperatures, comprising:
receiving, at a gateway device, temperature data transmitted from a sensor device via a sub-gigahertz (sub-GHz) communication protocol, the temperature data being based on a temperature of a food product measured with a temperature sensor of the sensor device;
transmitting the temperature data from the gateway device to a server device via a network communication protocol that is different from the sub-GHz communication protocol; and
causing the temperature of the food product to be displayed on a client device based on the temperature data being received by the server device over the network communication protocol.

2. The method of claim 1, wherein the network communication protocol is an internet protocol (IP)-based network protocol.

3. The method of claim 1, wherein the network communication protocol is a message queuing telemetry transport (MQTT) protocol.

4. The method of claim 3, wherein transmitting the temperature data from the gateway device includes formatting the temperature data as a network message comprising a topic identifier and a message payload compatible with the MQTT protocol.

5. The method of claim 1, wherein the sensor device measures the temperature of the food product based on the sensor device being at least partially positioned within the food product.

6. The method of claim 1, wherein causing the temperature of the food product to be displayed on the client device includes transmitting the temperature data from the server device to the client device, the temperature data including instructions for displaying the temperature on the client device.

7. The method of claim 1, wherein the sub-GHz communication protocol operates at a frequency of about 433 MHz to about 915 MHz.

8. The method of claim 1, wherein receiving the temperature data at the gateway device includes receiving the temperature data transmitted through an enclosure of a cooking apparatus.

9. The method of claim 1, wherein receiving the temperature data includes receiving the temperature data at a dynamic transmission interval of the sensor device, the dynamic transmission interval comprising one or more delayed transmissions in response to the sensor device detecting one or more active transmissions of one or more additional sensor devices.

10. The method of claim 1, further comprising transmitting configuration data to the sensor device via the sub-GHz communication protocol, wherein the configuration data indicates a dynamic transmission interval for the sensor device to implement.

11. The method of claim 10, wherein the gateway device is one of a plurality of gateway devices accessible to the sensor device via the sub-GHz communication protocol, and further comprising transmitting the configuration data to the sensor device from the gateway device in response to the server device determining that the gateway device has a strongest signal strength among the plurality of gateway devices and in response to the server device designating the gateway device as a primary gateway device for the sensor device.

12. The method of claim 1, wherein the temperature data includes an adjusted temperature of the food product as measured and calibrated by the sensor device.

13. The method of claim 1, wherein the temperature data indicates one or more of an ambient temperature, a battery level, device information, or debug data for the sensor device, and further comprising causing one or more of the ambient temperature, battery level, device information, or debug data to be displayed on the client device based on the temperature data being received at the server device.

14. The method of claim 1, wherein receiving the temperature data includes receiving the temperature data over the sub-GHz communication protocol with the gateway device from up to 1500 feet away from the sensor device without obstruction.

15. The method of claim 1, wherein receiving the temperature data includes receiving the temperature data over the sub-GHz communication protocol with the gateway device through an enclosure of a cooking apparatus from up to 560 feet away from the sensor device.

16. The method of claim 1, further comprising, with the gateway device:
receiving additional temperature data transmitted from an additional sensor device, wherein the additional temperature data is based on a temperature of an additional food product or an ambient temperature; and
transmitting the additional temperature data to the server device via the network communication protocol for displaying the temperature of the additional food product or the ambient temperature on the client device.

17. The method of claim 16, further comprising receiving the additional temperature data via the sub-GHz communication protocol.

18. The method of claim 16, further comprising receiving the additional temperature data via a wired connection of the additional sensor device with the gateway device.

19. A system, comprising:
a sensor device configured to:
determine a temperature of a food product with a temperature sensor;
generate temperature data based on the determined temperature; and
transmit the temperature data via a sub-gigahertz (sub-GHz) communication protocol;
a gateway device configured to:
receive the temperature data via the sub-GHz communication protocol; and
transmit the temperature data using a network communication protocol that is different than the sub-GHz communication protocol; and
a server device configured to:
receive the temperature data via the network communication protocol; and
cause the temperature of the food product to be displayed on a client device based on the temperature data.

20. A non-transitory computer-readable storage medium having instructions stored thereon which, when executed by a processor, cause the processor to perform operations of:
receiving, at a gateway device, temperature data transmitted from a sensor device via a sub-gigahertz (sub-GHz) communication protocol, the temperature data being based on a temperature of a food product measured with a temperature sensor of the sensor device;
transmitting the temperature data from the gateway device to a server device via a network communication protocol that is different from the sub-GHz communication protocol; and
causing the temperature of the food product to be displayed on a client device based on the temperature data being received by the server device over the network communication protocol.
